(19) United States
(12) Patent Application Publication
(10) Pub. No.: US 2004/0113387 A1
(43) Pub. Date: Jun. 17, 2004

(54) Folding device for bicycle body and transom

(76) Inventor: Xiongxin Ying, Yong Kang City (CN)

Correspondence Address: Mitchell J. Weinstein, Welsh & Katz, Ltd., 22nd Floor, 120 S. Riverside Drive, Chicago, IL, 60606, US

(21) Appl. No.: 10/729,029

(22) Filed: Dec. 5, 2003

(30) Foreign Application Priority Data
Dec. 5, 2002 (CN) 02 2 80221.5

(51) Int. Cl. B62K 5/00

(52) U.S. Cl. 280/287

(57) ABSTRACT

The present utility discloses a folding device for bicycle body and transom, which comprises bicycle body, a transom jointed to the bicycle body by means of hinge, a tightening lug bolt and a eccentric axle which is inserted into a hole on head of said lug bolt and body of the bicycle successively to attain hinge joint, a groove for receiving and securing the end of the lug bolt is provided on said transom, the end of lug bolt is engaged with a nut which is embedded into said groove in order to joint the transom with the body. The folding device further comprises a torsion spring, one end of which is fixed to the bicycle body and the other end is disposed on the lug bolt. The eccentric axle is connected to a lever. The head of said nut is fastened to the lug bolt by a screw. The device has the advantages of reasonable construction, more convenient and timesaving folding procedure, safe and reliable manipulation and beautiful, tasteful outward appearance, etc.

### TECHNICAL FIELD

The present utility relates to a folding device, in particular to an improved folding device for the body of an electrobicycle or ordinary bicycle.

### BACKGROUND ART

To facilitate transportation, packing and carrying, electrobicycle or ordinary bicycle are generally designed to be of foldable structure. The current means of folding the body of an electrobicycle or ordinary bicycle is to joint the transom to the bicycle body with hinge and then to fix them by tightening screws. Although folding of the bicycle body can be achieved in this way, yet in operation, tools must be used to amount and dismount the screws in order to proceed the folding. The folding is not only troublesome, but also time-consuming; additionally, the screw is easy to loosen, affecting normal driving.

### SUMMARY OF THE INVENTION

To overcome the shortcoming of prior art that tools must be used to proceed the folding of electrobicycle or ordinary bicycle, the object of the present utility is to provide a more convenient and more timesaving folding device for transom and bicycle body.

The technical solution adopted by the present utility is that the folding device comprises bicycle body, a transom jointed to the bicycle body by means of hinge, a tightening lug bolt and a eccentric axle which is inserted into a hole on head of said lug bolt and body of the bicycle successively to attain hinge joint, a groove for receiving and securing the end of the lug bolt is provided on said transom, the end of lug bolt is engaged with a nut which is embedded into said groove in order to joint the transom with the body.

The folding device further comprises a torsion spring, one end of which is fixed to the bicycle body and the other end is disposed on the lug bolt.

The eccentric axle is connected to a lever.

The head of said nut is fastened to the lug bolt by a screw.

In the present utility, with rotation of the eccentric axle, the tightening lug bolt is made to move axially in the groove of the transom by linkage with eccentric axle, so as to loosen or tighten the connection of the bicycle body and transom. Through tight pressing of the torsion spring on the tightening lug bolt to ensure that the tightening lug bolt will not detach from the groove, even the device is loosened, safe driving is guaranteed. The device has such advantages as simple and reasonable construction, more convenient and timesaving folding operation, and beautiful, tasteful outward appearance, etc.

### DESCRIPTION OF THE DRAWING

FIG. 1 is a schematic diagram of the members of the folding device according to the present utility.

FIG. 2 is a schematic diagram of the folding device according to the present utility in folding status.

FIG. 3 is a schematic diagram of the folding device according to the present utility in fastening status.

### Specific Embodiment

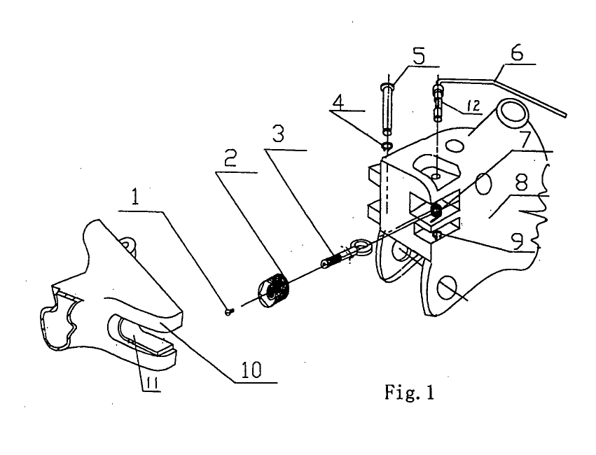

FIG. 1 shows the specific embodiment of the folding device for bicycle body and transom of the present utility. It comprises the bicycle body 8 and a transom 10. The transom 10 is jointed to the bicycle body 8 by means of a hinge axle 5. The end of hinge axle 5 is locked within the axle hole by a garter spring 4. A tightening lug bolt 3, with a hole on its head, is jointed to the bicycle body 8 by means of an eccentric axle 12. Namely, insert the eccentric axle 12 into a hole on bicycle body 8 and the hole on the head of lug bolt 3 successively so as to attain hinge joint between bicycle body 8 and lug bolt 3. A groove 11 is provided on said transom 10, which may be formed in U or V shape for receiving the end of the lug bolt 3. The eccentric axle 12 is locked by a garter spring 9 onto the body 8.

The end of the tightening lug bolt 3 is engaged with a nut 2, a fixing screw 1 may be used to ensure the connection between lug bolt 3 and nut 2. The end of tightening lug bolt 3 is received within the groove 11 of transom 10 and the nut 2 is chucked by the shoulder of groove 11 of transom 10. The nut 2 can be a knurling nut or other kind nut. Other known fastening structure to keep the end of lug bolt 3 detachable engaged with the groove 11 can be used in this utility.

In order to make the fastening safer and more reliable, a torsion spring 7 is provided around the eccentric axle 12. One end of the torsion spring 7 is fixed to the bicycle body 8 and the other end disposed on the tightening lug bolt 3. In unbending position, the torsion spring 7 presses tightly on the tightening lug bolt 3, so that even the folding device of the present utility loosens, the tightening lug bolt 3 will not disengage with the groove 11 so as to make the fastening of the bicycle body 8 and the transom 10 more reliable.

For the convenience of rotation, a lever 6 is provided fixedly on the eccentric axle 12.

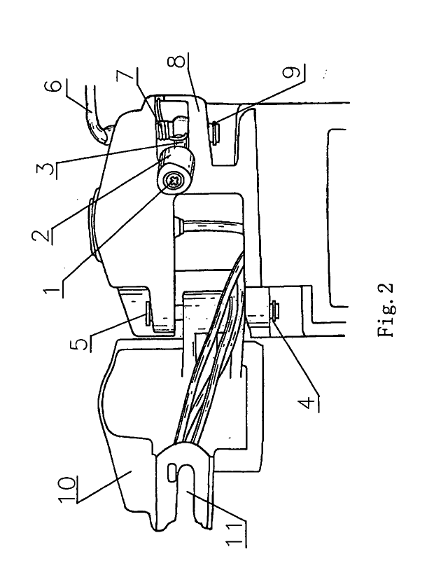

While in driving status, the eccentric axle 12 is partial to the opposite side of the transom 10. Refer to FIG. 2, while folding, the lever 6 is first turned, and then the eccentric axle 12 rotates along with it. The central of the eccentric axle 12 becomes close to the transom 10, as a result, the tightening lug bolt 3 is made to move axially in the groove 11 of the transom 10 so as to loosen the connection between lug bolt 3 and transom 10. Then turn the nut 2 around to make the tightening lug bolt 3 come apart from the groove 11. Finally, rotate the transom 10 close to the bicycle body 8 around hinge axle 5 to complete the operation of folding.

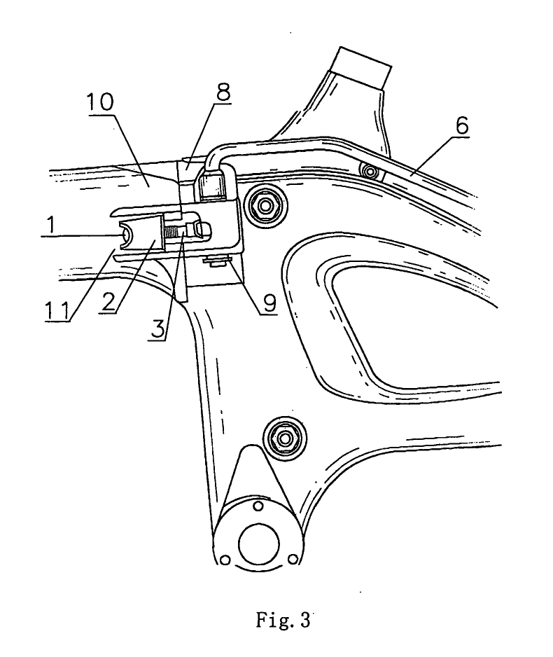

Refer to FIG. 3, conversely, at the time of unbending, turn the transom 10 around hinge axle 5 to the side in line with bicycle body 8, and then rotate the lug bolt 3 as well as the nut 2 into the groove 11 of transom 10, turn level 6 to make the eccentric axle 12 partial to the opposite side of transom 10, at the same time, the tightening lug bolt 3 moves axially to the bicycle body 8 along with the eccentric axle 12, as a result, the nut 2 is tightly chucked within the groove 11 by the shoulder of the groove 11 of transom 10. Fastening operation can be easily achieved as well by the aforesaid structure.

I claim:

1. A folding device for bicycle body and transom, comprising bicycle body (8), a transom (10) jointed to the bicycle body (8) by means of hinge, characterized in that:
the folding device further comprises a tightening lug bolt (3) and a eccentric axle (12) which is inserted into a hole on head of said lug bolt (3) and body (8) of the bicycle to attain hinge joint, a groove (11) for receiving and securing the end of the lug bolt (3) is provided on said transom (10).

2. The folding device for bicycle body and transom according to claim 1, wherein the end of lug bolt (3) is engaged with a nut (2) which is embedded into said groove (11) in order to joint the transom (10) with the body (8).

3. The folding device for bicycle body and transom according to claim 1, wherein further comprises a torsion spring (7), one end of which is fixed to the bicycle body (8) and the other end is disposed on the lug bolt (3).

4. The folding device for bicycle body and transom according to claim 1 to 3, wherein the eccentric axle (12) is connected to a lever (6).

5. The folding device for bicycle body and transom according to claim 1, wherein the head of said nut (2) is fastened to said lug bolt (3) by a screw (1).
